(19) United States
(12) Patent Application Publication
(10) Pub. No.: US 2022/0196962 A1
(43) Pub. Date: Jun. 23, 2022

(54) LENS BARREL, LENS DEVICE, MANUFACTURING METHOD OF LENS BARREL

(71) Applicant: FUJIFILM Corporation, Tokyo (JP)

(72) Inventor: Goroh TAKADA, Saitama-shi (JP)

(73) Assignee: FUJIFILM Corporation, Tokyo (JP)

(21) Appl. No.: 17/694,701

(22) Filed: Mar. 15, 2022

Related U.S. Application Data
(63) Continuation of application No. PCT/JP2020/024425, filed on Jun. 22, 2020.

(30) Foreign Application Priority Data
Sep. 30, 2019 (JP) 2019-180137

(51) Int. Cl. G02B 7/02

(52) U.S. Cl. CPC G02B 7/026; G03B 17/12; G02B 7/021; G02B 7/025

(57) ABSTRACT

A lens barrel includes: a tubular cam follower; a cam barrel having a cam groove that is engaged with the cam follower; and a lens support member that supports a lens, the lens support member has a protruding portion that protrudes outward in a radial direction of the lens from an outer peripheral portion of the lens support member and that is inserted into the cam follower, and the cam follower and the lens support member are stuck to each other in a non-fastened state.

### CROSS REFERENCE TO RELATED APPLICATION

This is a continuation of International Application No. PCT/JP2020/024425 filed on Jun. 22, 2020, and claims priority from Japanese Patent Application No. 2019-180137 filed on Sep. 30, 2019, the entire disclosures of which are incorporated herein by reference.

### BACKGROUND OF THE INVENTION

### 1. Field of the Invention

The present invention relates to a lens barrel, a lens device comprising the lens barrel, and a manufacturing method of a lens barrel.

### 2. Description of the Related Art

JP2009-86567A describes a lens barrel in which a lens frame and a roller that is engaged with a cam groove of a cam barrel are fixed to each other by a screw and an adhesive. In the lens barrel, the lens frame and the roller are fixed in a state in which a part of the roller is inserted into a recessed portion provided in the lens frame.

JP2004-94022A, JP2017-49466A, JP2006-23359A, JP2005-292359A, and JP2006-178236A describe a lens device in which a movable lens frame and an engagement member that is engaged with a cam groove of a cam barrel are fixed to each other by a screw. In the lens devices, the lens frame and the engagement member are fixed in a state in which a part of the engagement member is inserted into a recessed portion provided in the lens frame.

### SUMMARY OF THE INVENTION

One embodiment according to the technique of the present disclosure provides a lens barrel in which the degree of freedom in adjusting the position of a lens is enhanced so that a lens device having desired optical properties can be manufactured at low cost, a lens device comprising the lens barrel, and a manufacturing method of a lens barrel.

According to one aspect of the technique of the present disclosure, there is provided a lens barrel comprising: a tubular cam follower; a cam barrel having a cam groove that is engaged with the cam follower; and a lens support member that supports a lens, in which the lens support member has a protruding portion that protrudes outward in a radial direction of the lens from an outer peripheral portion of the lens support member and that is inserted into the cam follower, and the cam follower and the lens support member are stuck to each other in a non-fastened state.

According to one aspect of the technique of the present disclosure, there is provided a lens device comprising the lens barrel.

According to one aspect of the technique of the present disclosure, there is provided a manufacturing method of a lens barrel including a lens support member that supports a lens, a protruding portion that protrudes outward in a radial direction of the lens from an outer peripheral portion of the lens support member, a tubular cam follower into which the protruding portion is inserted and inside which the cam follower and the protruding portion are stuck to each other, and a cam barrel having a cam groove that is engaged with the cam follower, the manufacturing method comprising: moving the protruding portion in a state in which the lens support member with the protruding portion inserted into the cam follower is disposed inside the cam barrel, determining a position of the protruding portion on the basis of an image obtained by imaging a test chart via the lens in each movement position, and then sticking the protruding portion and the cam follower to each other at the position.

According to one aspect of the technique of the present disclosure, there is provided a lens barrel comprising: a tubular cam follower; a cam barrel having a cam groove that is engaged with the cam follower; and a lens support member that supports a lens, in which the lens support member has a protruding portion that protrudes outward in a radial direction of the lens from an outer peripheral portion of the lens support member and that is inserted into the cam follower, three sets of the protruding portion and the cam follower are provided at an equal interval in a circumferential direction of the lens, and in a first set out of the three sets, a gap is formed in a specific direction between the protruding portion and an interior wall of the cam follower, and a size of the gap is equal to or less than a size of a gap in the specific direction formed between the protruding portion and an interior wall of the cam follower in each of two second sets except the first set out of the three sets.

According to one aspect of the technique of the present disclosure, there is provided a lens barrel comprising: a tubular cam follower; a cam barrel having a cam groove that is engaged with the cam follower; and a lens support member that supports a lens, in which the lens support member has a protruding portion that protrudes outward in a radial direction of the lens from an outer peripheral portion of the lens support member and that is inserted into the cam follower, and the cam follower has one or zero contact surfaces that come into contact with the lens support member inside the cam follower and in an axial direction.

According to one aspect of the technique of the present disclosure, there is provided a lens barrel comprising: a tubular cam follower; a cam barrel having a cam groove that is engaged with the cam follower; and a lens support member that supports a lens, in which the lens support member has a protruding portion that protrudes outward in a radial direction of the lens from an outer peripheral portion of the lens support member and that is inserted into the cam follower, the cam follower has a plurality of contact surfaces that come into contact with the lens support member in an axial direction, and the number of contact surfaces that overlap with the other contact surface as viewed in the axial direction, out of the plurality of contact surfaces, is zero.

According to one aspect of the technique of the present disclosure, there is provided a lens barrel comprising: a tubular cam follower; a cam barrel having a cam groove that is engaged with the cam follower; and a lens support member that supports a lens, in which the lens support member has a protruding portion that protrudes outward in a radial direction of the lens from an outer peripheral portion of the lens support member and that is inserted into the cam follower, a gap is formed in a specific direction between the protruding portion and an interior wall of the cam follower, and the specific direction is a movement direction of the lens, an axial direction of the cam follower, and a direction orthogonal to the movement direction and the axial direction.

According to the present invention, it is possible to provide a lens barrel in which the degree of freedom in adjusting the position of a lens is enhanced so that a lens device having desired optical properties can be manufactured at low cost, a lens device comprising the lens barrel, and a manufacturing method of a lens barrel.

### BRIEF DESCRIPTION OF THE DRAWINGS

FIG. 1 is a perspective view showing a configuration of an external appearance of a lens barrel 100 included in a lens device of an embodiment of the present invention.

FIG. 2 is a partial cross-sectional view of the lens barrel 100 of FIG. 1.

FIG. 3 is a schematic cross-sectional view taken along line A-A of FIG. 2.

FIG. 4 is an enlarged view of a range H shown in FIG. 3.

FIG. 5 is a schematic view of a cam follower 41 and a protruding portion 31 shown in FIG. 4 as viewed from the outside in a radial direction.

FIG. 6 is a schematic view showing a manufacturing system 200 of the lens barrel 100 shown in FIG. 1.

FIG. 7 is a schematic view showing a modification example of the cross-section taken along the line A-A of FIG. 2.

### DESCRIPTION OF THE PREFERRED EMBODIMENTS

Hereinafter, embodiments of the present invention will be described with reference to the drawings.

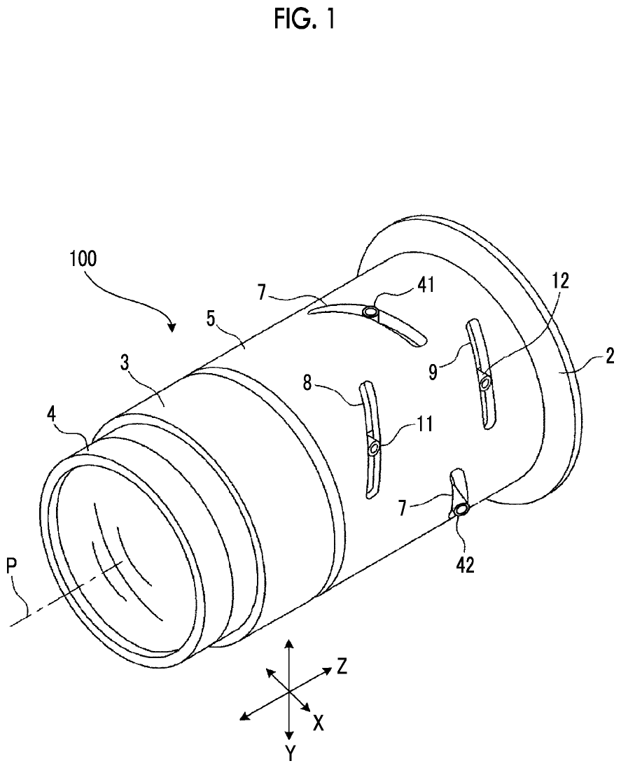

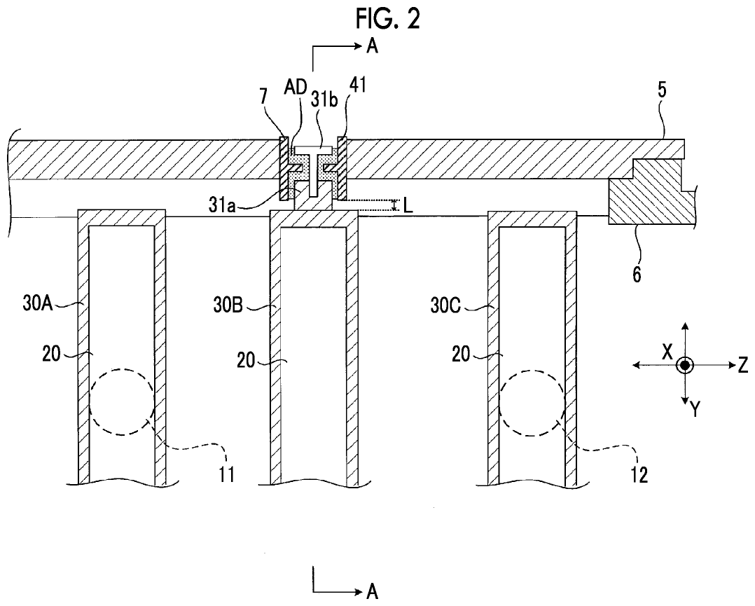

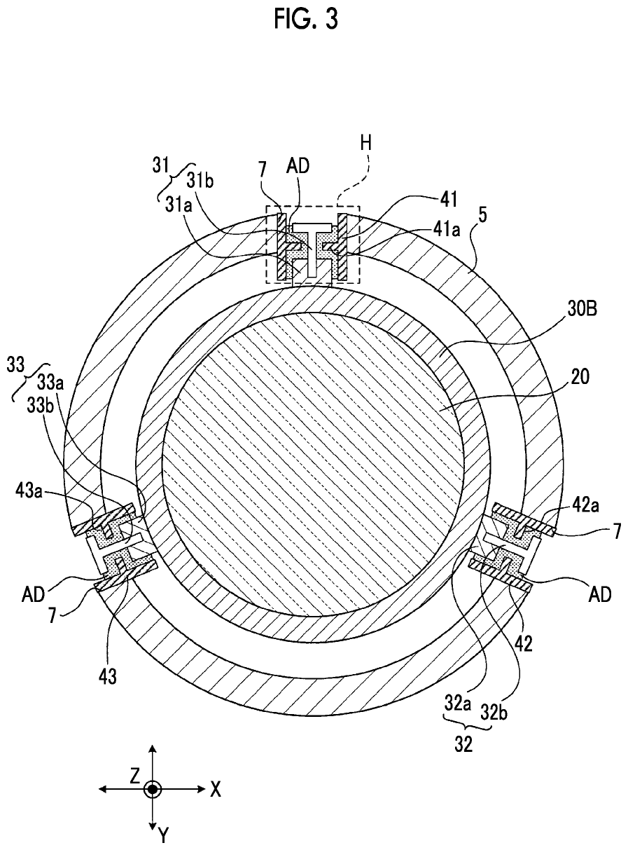

FIG. 1 is a perspective view showing a configuration of an external appearance of a lens barrel 100 included in a lens device according to an embodiment of the present invention. FIG. 2 is a partial cross-sectional view of the lens barrel 100 of FIG. 1. FIG. 3 is a schematic cross-sectional view taken along line A-A of FIG. 2. The lens device is formed by covering an outer peripheral surface of a cam barrel 5 of the lens barrel 100 shown in FIG. 1 with a zoom ring that is integrally connected thereto. In FIG. 1, a movement direction of a lens included in the lens barrel 100 is denoted by a direction Z, one direction out of two directions perpendicular to the direction Z is denoted by a direction X, and the other direction out of the two directions is denoted by a direction Y.

The lens barrel 100 has a mount ring 2 at a rear end thereof and is attached to a camera body, a projector body, or the like. The lens barrel 100 is provided with a focus ring 3 at a front end thereof, and with the rotation of the focus ring 3, a focus lens barrel 4 incorporating the focus lens group advances and retreats via a helicoid to bring to a focus.

A cam barrel 5 is provided behind the focus ring 3. As shown in FIG. 2, the cam barrel 5 is rotatably supported on the outer side of a fixed barrel 6, and the position thereof is restricted so as not to move in the direction Z. Three types of cam grooves 7, 8, and 9 are formed in the cam barrel 5. The cam grooves 7 are formed at three locations that are rotationally symmetric with each other at 120° with respect to an optical axis P, and are each engaged with a cam follower 41, 42, or 43 (see FIG. 3). For convenience of illustration, FIG. 1 shows only two cam grooves 7 and the cam followers 41 and 42 that are each engaged with the cam groove 7. The cam grooves 8 are formed at three locations that are rotationally symmetric with each other at 120° with respect to the optical axis P, and are each engaged with a cam follower 11. The cam grooves 9 are formed at three locations that are rotationally symmetric with each other at 120° with respect to the optical axis P, and are each engaged with a cam follower 12. For convenience of illustration, FIG. 1 shows only one cam groove 8 and one cam follower 11 that is engaged with the cam groove 8, and one cam groove 9 and one cam follower 12 that is engaged with the cam groove 9. The cam grooves 8 and 9 are provided at positions different in phase in the rotation direction with respect to the cam groove 7 such that the cam grooves 7, 8, and 9 do not interfere with each other.

Lens frames 30A, 30B, and 30C each individually support a lens group 20. The cam follower 41 is stuck to the lens frame 30B (see FIG. 2). The cam followers 42 and 43 are stuck to the lens frame 30B as in the cam follower 41 (see FIG. 3). Further, the cam follower 11 is stuck to the lens frame 30A, and the cam follower 12 is stuck to the lens frame 30C. In a case where the cam barrel 5 is rotated, the lens frames 30A, 30B, and 30C move all at once in the direction Z on the basis of corresponding shapes of the cam grooves 7, 8, and 9, so that magnification change is performed. Note that the number of lenses included in the lens group 20 need only be at least one. In FIG. 1, an axial direction of the cylindrical cam follower 41 is the direction Y.

As shown in FIG. 3, the lens frame 30B is formed of a substantially cylindrical member, and includes columnar protruding portions 31, 32, and 33 that protrude outward in a radial direction of the lens group 20 from an outer peripheral portion of the lens frame 30B.

The protruding portions 31, 32, and 33 are disposed at an equal interval in a circumferential direction of the lens group 20, and are inserted into the cylindrical cam followers 41, 42, and 43, respectively. The protruding portions 31, 32, and 33 are stuck to the cam followers 41, 42, and 43 by an adhesive AD, inside the cam followers 41, 42, and 43, respectively.

The protruding portion 31 is formed of a cylindrical body portion 31a provided inward in the radial direction of the lens group 20 and a substantially T-shaped pin 31b fixed to a surface of the body portion 31a on an outer side in the radial direction. The pin 31b is screwed into a screw hole formed in the body portion 31a and is fixed to the body portion 31a.

The body portion 31a may be integrally molded with the lens frame 30B, or may be formed of a separate member fixed to the lens frame 30B by a screw or the like.

The protruding portion 32 has the same configuration as the protruding portion 31, and is formed of a cylindrical body portion 32a provided inward in the radial direction of the lens group 20 and a substantially T-shaped pin 32b fixed to a surface of the body portion 32a on an outer side in the radial direction. The pin 32b is screwed into a screw hole formed in the body portion 32a and is fixed to the body portion 31a. The body portion 32a may be integrally molded with the lens frame 30B, or may be formed of a separate member fixed to the lens frame 30B by a screw or the like.

The protruding portion 33 has the same configuration as the protruding portion 31, and is formed of a cylindrical body portion 33a provided inward in the radial direction of the lens group 20 and a substantially T-shaped pin 33b fixed to a surface of the body portion 33a on an outer side in the radial direction. The pin 33b is screwed into a screw hole formed in the body portion 33a and is fixed to the body portion 33a. The body portion 33a may be integrally molded with the lens frame 30B, or may be formed of a separate member fixed to the lens frame 30B by a screw or the like.

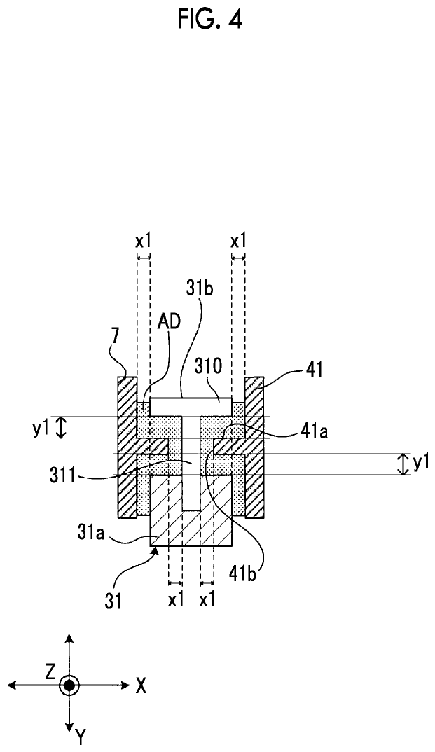

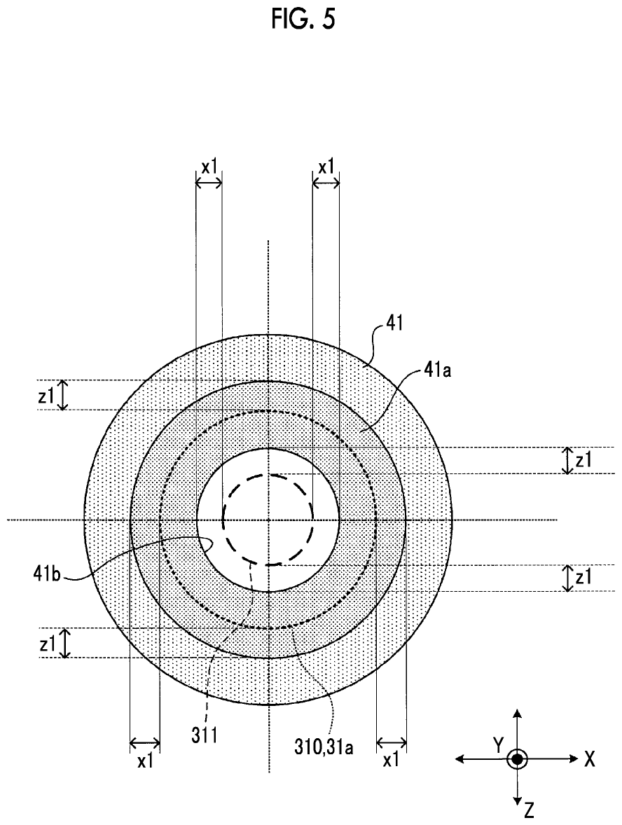

FIG. 4 is an enlarged view of a range H shown in FIG. 3. FIG. 5 is a schematic view of the cam follower 41 and the protruding portion 31 shown in FIG. 4 as viewed from the outside in the radial direction.

As shown in FIGS. 4 and 5, the cam follower 41 has an annular reduced diameter portion 41a in which the inner diameter thereof is reduced inside the cam follower 41. The pin 31b is formed of a cylindrical shaft portion 311 extending in the radial direction (direction Y in FIGS. 4 and 5) of the lens group 20 and a disk-shaped flat plate portion 310 orthogonal to the radial direction.

The diameter of the shaft portion 311 of the protruding portion 31 is smaller than the diameter of an opening 41b of the reduced diameter portion 41a of the cam follower 41. The shaft portion 311 is disposed so as to penetrate the opening 41b. The diameter of the flat plate portion 310 of the protruding portion 31 is larger than the diameter of the opening 41b, and is the same as the diameter of the body portion 31a.

As in the cam follower 41, the cam follower 42 has a reduced diameter portion 42a, and the shaft portion of the pin 32b penetrates the opening of the reduced diameter portion 42a. As in the cam follower 41, the cam follower 43 has a reduced diameter portion 43a, and the shaft portion of the pin 33b penetrates the opening of the reduced diameter portion 43a.

The cam follower 11 and the lens frame 30A shown in FIG. 2 are stuck to each other by, for example, a screw. Further, the cam follower 12 and the lens frame 30C shown in FIG. 2 are stuck to each other by, for example, a screw.

The position of the lens frame 30B shown in FIG. 3 is adjusted as follows. The lens frame 30B is disposed in the cam barrel 5 in a state in which the protruding portions 31, 32, and 33 are inserted into the cam followers 41, 42, and 43, respectively, before the sticking by the adhesive AD. Then, an attachment for gripping is attached to the flat plate portion 310 of the pin 31b of the protruding portion 31, and the attachment is gripped by an industrial robot.

The industrial robot holds the lens frame 30B in a state in which the plane perpendicular to the optical axis of the lens group 20 is parallel to the direction Y and the direction X, the central axis of the protruding portion 31 and the central axis of the cam follower 41 match each other, and the interior wall of the cam follower 41 and the protruding portion 31 are not in contact with each other. This state is referred to as a reference state.

FIGS. 2 and 3 show a state in which the cam followers 41, 42, and 43 and the protruding portions 31, 32, and 33 are stuck to each other by the adhesive AD in the reference state, respectively.

As shown in FIG. 2, in the reference state, there is a gap having a width L in the direction Y between the lens frame 30B and the cam follower 41.

As shown in FIG. 4, in the reference state, a gap having a width y1 is formed in the direction Y between the protruding portion 31 and the interior wall of the cam follower 41. In addition, in the present specification, the “gap” between two objects means that the two objects are not in direct contact with each other. In other words, the “gap” in the present specification includes a case where there is a space between two objects and a case where another object is present between the two objects. For example, a structure in which there is a space having the width L between the lens frame 30B and the cam follower 41 shown in FIG. 2 is also referred to as “there is a gap between the lens frame 30B and the cam follower 41”, and a structure in which a space between the protruding portion 31 and the interior wall of the cam follower 41 is filled with the adhesive AD as shown in FIG. 4 is also referred to as “there is a gap between the protruding portion 31 and the interior wall of the cam follower 41”. Further, the “gap between two objects in a specific direction” means that the two objects have a “gap” in a specific direction therebetween. The “specific direction” is any direction. The width y1 has a value smaller than the width L shown in FIG. 2.

Further, as shown in FIG. 4, in the reference state, a gap having a width x1 is formed in the direction X between the protruding portion 31 and the interior wall of the cam follower 41.

Further, as shown in FIG. 5, in the reference state, a gap having a width z1 is formed in the direction Z between the protruding portion 31 and the interior wall of the cam follower 41. The width y1, the width x1, and the width z1 have, for example, the same value, but may have different values.

In the reference state, each of the size of the gap in the direction Y formed between the protruding portion 32 and the interior wall of the cam follower 42, and the size of the gap in the direction Y formed between the protruding portion 33 and the interior wall of the cam follower 43 is the width y1 or more.

Further, in the reference state, each of the size of the gap in the direction X formed between the protruding portion 32 and the interior wall of the cam follower 42, and the size of the gap in the direction X formed between the protruding portion 33 and the interior wall of the cam follower 43 is the width x1 or more.

Further, in the reference state, each of the size of the gap in the direction Z formed between the protruding portion 32 and the interior wall of the cam follower 42, and the size of the gap in the direction Z formed between the protruding portion 33 and the interior wall of the cam follower 43 is the width z1 or more.

Therefore, in a case where the lens frame 30B is moved to one side or the other side of the direction X from the reference state, the lens frame 30B can be moved until the protruding portion 31 comes into contact with the interior wall of the cam follower 41, that is, by a distance of the width x1.

Further, in a case where the lens frame 30B is moved to one side or the other side of the direction Z from the reference state, the lens frame 30B can be moved until the protruding portion 31 comes into contact with the interior wall of the cam follower 41, that is, by a distance of the width z1.

Further, in a case where the lens frame 30B is moved to one side or the other side of the direction Y from the reference state, the lens frame 30B can be moved until the protruding portion 31 comes into contact with the interior wall of the cam follower 41, that is, by a distance of the width y1. Since the width L is larger than the width y1, the cam follower 41 and the lens frame 30B are not in contact with each other, in a state in which the lens frame 30B is moved in the direction Y and the body portion 31a of the protruding portion 31 is in contact with the interior wall of the cam follower 41.

Further, when the lens frame 30B is tilted toward one side or the other side of the direction Z from the reference state, the lens frame 30B can be rotated around an axis (Ox axis) extending in the direction X and intersecting the optical axis until the protruding portion 31 comes into contact with the interior wall of the cam follower 41.

Further, the lens frame 30B can be rotated around an axis (Oy axis) extending in the direction Y and intersecting the optical axis, in a range in which the protruding portions 32 and 33 come into contact with the interior walls of the cam followers 42 and 43 from the reference state, respectively.

The industrial robot adjusts the optimal position of the lens frame 30B while changing the position in the direction X, the position in the direction Y, the position in the direction Z, the rotation angle around the Ox axis, and the rotation angle around the Oy axis of the lens frame 30B, and holds the lens frame 30B at that position. Then, in this state, the insides of the cam followers 41, 42, and 43 are filled with the adhesive AD and cured, so that the lens frame 30B and the cam followers 41, 42, and 43 are stuck to each other.

As described above, in the reference state, gaps by which the lens frame 30B can be moved in the directions X, Y, and Z are present between the interior walls of the cam followers 41, 42, and 43 and the protruding portions 31, 32, and 33, respectively. That is, in each of three sets of the cam follower and the protruding portion, the interior wall of the cam follower and the protruding portion are not in contact with each other. Therefore, the protruding portions 31, 32, and 33 and the interior walls of the cam followers 41, 42, and 43 have gaps in the direction Y therebetween, respectively, even in a case where the protruding portion 31 is stuck to the cam follower 41 in a state in which the protruding portion 31 is moved to the maximum in the direction Y. Further, in this case, the protruding portions 32 and 33 and the interior walls of the cam followers 42 and 43 have gaps therebetween in the axial directions of the cam followers 42 and 43, respectively.

Further, the protruding portions 31, 32, and 33 and the interior walls of the cam followers 41, 42, and 43 have gaps in the direction X therebetween, respectively, even in a case where the protruding portion 31 is stuck to the cam follower 41 in a state in which the protruding portion 31 is moved to the maximum in the direction X. Further, in this case, the protruding portions 32 and 33 and the interior walls of the cam followers 42 and 43 have gaps therebetween in the axial directions of the cam followers 42 and 43, respectively.

Further, the protruding portions 31, 32, and 33 and the interior walls of the cam followers 41, 42, and 43 have gaps in the direction Z therebetween, respectively, even in a case where the protruding portion 31 is stuck to the cam follower 41 in a state in which the protruding portion 31 is moved to the maximum in the direction Z. Further, in this case, the protruding portions 32 and 33 and the interior walls of the cam followers 42 and 43 have gaps therebetween in the axial directions of the cam followers 42 and 43, respectively.

That is, no matter how the lens frame 30B is moved and stuck within the movable range thereof, each of the cam followers 41, 42, and 43 stuck to the lens frame 30B has one or zero contact surfaces that come into contact with the lens frame 30B inside the cam followers 41, 42, and 43 and in the axial directions.

As in the related art, in a case where the cam follower and the lens frame are fastened and fixed by a screw, the cam follower is sandwiched between the screw screwed to the lens frame and the lens frame. In this way, in the configuration in which the lens frame and the cam follower are fixed by being fastened with a screw, the cam follower has two contact surfaces with the lens frame and a portion consisting of the screw, and the two contact surfaces overlap with each other as viewed in the radial direction. In this state, it is particularly difficult to adjust the position of the lens frame in the radial direction.

In the lens barrel 100 of the present embodiment, the cam followers 41, 42, and 43 and the lens frame 30B are stuck to each other in a non-fastened state. The non-fastened state here means a state in which the cam followers 41, 42, and 43 and the lens frame 30B are not fastened by a fastening member such as a screw.

That is, a configuration in which the cam follower and the lens frame are fastened with a screw as in the related art is referred to as a fastened state. In the fastened state, a tubular member of the cam follower, which is located on the outermost periphery, is sandwiched between a portion that is inserted into the inside of the tubular member (specifically, a screw head) and the lens frame or a portion that is fixed thereto, which is not inserted into the inside of the tubular member.

On the other hand, in the present embodiment, the cam followers 41, 42, and 43 are not sandwiched between the protruding portions 31, 32, and 33 that are inserted into the insides of the cam followers and the outer peripheral portion of the lens frame 30B. That is, each of the cam followers 41, 42, and 43 has a configuration in which the number of contact surfaces that come into contact with the lens frame 30B in the axial direction is one or zero.

Therefore, the configuration in which each of the cam followers 41, 42, and 43 has one or zero contact surfaces that come into contact with the lens frame 30B inside the cam followers 41, 42, and 43 and in the axial directions can be referred to as the above-described non-fastened state. As described above, the cam followers 41, 42, and 43 and the lens frame 30B are stuck to each other in a non-fastened state, so that the amount of position adjustment of the lens frame 30B in the radial direction can be sufficiently secured.

In the above description, the width L in FIG. 2 is larger than the width y1 in FIG. 4, but a configuration in which the width L is the same as the width y1 is also conceivable. In this case, the end surface of the cam follower 41 on the lens frame 30B side comes into contact with the outer peripheral portion of the lens frame 30B in a state in which the lens frame 30B is moved to the outermost side of the direction Y from the reference state. That is, the cam follower 41 has two contact surfaces that come into contact with the lens frame 30B in the axial direction.

However, the two contact surfaces do not overlap with each other as viewed in the axial direction of the cam follower 41. That is, the number of overlapping contact surfaces as viewed in the axial direction of the cam follower 41 is zero. That is, in the lens barrel 100, a configuration in which the cam follower 41 is sandwiched by the lens frame 30B cannot be established. Therefore, the amount of position adjustment of the lens frame 30B in the radial direction can be sufficiently secured. As described above, the configuration in which the cam follower 41 has two contact surfaces that come into contact with the lens frame 30B in the axial direction and the two contact surfaces do not overlap with each other as viewed in the axial direction of the cam follower can also be referred to as the above-described non-fastened state.

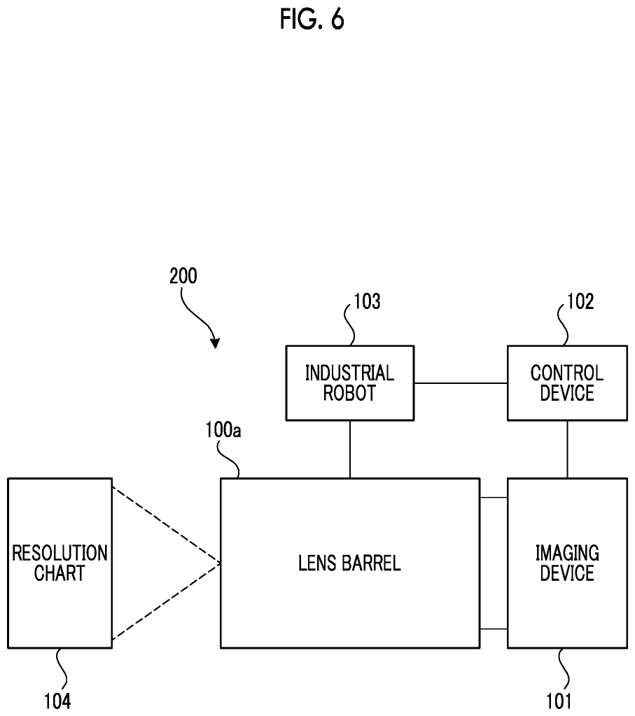

FIG. 6 is a schematic view showing a manufacturing system 200 of the lens barrel 100 shown in FIG. 1. The manufacturing system 200 comprises an imaging device 101, a control device 102, an industrial robot 103, and a resolution chart 104. The control device 102 controls the imaging device 101 and the industrial robot 103.

First, a lens barrel 100a in a state before the lens frame 30B in the cam barrel 5 of the lens barrel 100 and the cam followers 41, 42, and 43 are stuck to each other is prepared. In the lens barrel 100a, the lens frame 30B in a state in which the protruding portions 31, 32, and 33 are inserted into the cam followers 41, 42, and 43, respectively, is disposed inside the cam barrel 5. The other lens frame 30A and lens frame 30C are disposed inside the cam barrel 5 and are screwed to the cam followers 11 and 12, respectively.

The lens barrel 100a is disposed between the imaging device 101 and the resolution chart 104, and the arm of the industrial robot 103 and the attachment attached to the pin 31b of the lens frame 30B are connected to each other. The pin 31b may be gripped directly by the arm. The industrial robot 103 controls the position of the lens frame 30B to the reference state on the basis of the command from the control device 102.

In that state, the resolution chart 104 is imaged by the imaging device 101 via the lens barrel 100a. The control device 102 generates position adjustment information (movement direction and movement amount) of the lens frame 30B on the basis of the captured image output from the imaging device 101.

The control device 102 controls the industrial robot 103 so as to move the lens frame 30B in accordance with the position adjustment information. The movement direction is five directions of the direction X, the direction Y, the direction Z, the direction around the Ox axis, and the direction around the Oy axis. The industrial robot 103 moves the position of the lens frame 30B from the reference state on the basis of the command from the control device 102.

After that, the imaging of the resolution chart 104, the generation of the position adjustment information based on the captured image, and the movement of the lens frame 30B based on the position adjustment information are repeated until the optical properties of the lens barrel 100a are optimized.

Then, in a case where the optical properties of the lens barrel 100a are optimized, the adhesive AD is injected into each inside of the cam followers 41, 42, and 43 by an adhesive injection device (not shown), and the cam followers 41, 42, and 43 and the lens frame 30B are stuck to each other.

In the present embodiment, the positions of the lens frames 30A and 30C are not adjusted, but in a case where it is necessary to adjust the positions, the cam follower 11 and the lens frame 30A, and the cam follower 12 and the lens frame 30C need only be stuck to each other in a non-fastened state, as in the relationship between the cam follower 41 and the lens frame 30B.

As described above, the lens barrel 100 has a configuration in which the cam followers 41, 42, and 43 and the protruding portions 31, 32, and 33 inserted therein are stuck to each other in a non-fastened state, respectively. That is, the cam followers 41, 42, and 43 each do not have a portion sandwiched by the lens frame 30B (have less than two contact surfaces described above, or do not have two contact surfaces overlapping with each other in the axial direction of the cam follower described above).

With this configuration, the lens frame 30B can be moved at least in the direction Y by a sufficient amount in a state before sticking. The movement of the lens in the radial direction greatly contributes to the adjustment of the condensing position of light from an object. Therefore, the position of the lens frame 30B in the direction Y is made to be sufficiently adjustable, so that the optical properties of the lens barrel 100 can be adjusted to a desired state even in a case where an assembly error or the like has occurred in the lens frame 30A or the lens frame 30C.

Further, as shown in FIG. 3, the lens barrel 100 has gaps formed in the direction X between the protruding portions 31, 32, and 33 and the interior walls of the cam followers 41, 42, and 43, respectively. Therefore, in a state before sticking, the lens frame 30B can also be moved in the direction X. The movement of the lens in the direction X greatly contributes to the adjustment of the condensing position of light from the object. Therefore, the position of the lens frame 30B in the direction X is made to be adjustable, so that the optical properties of the lens barrel 100 can be adjusted to a desired state even in a case where an assembly error or the like has occurred in the lens frame 30A or the lens frame 30C.

Further, as shown in FIG. 2, the lens barrel 100 has gaps formed in the direction Z between the protruding portions 31, 32, and 33 and the interior walls of the cam followers 41, 42, and 43, respectively. Therefore, in the state before sticking, the lens frame 30B can be moved in the direction Z, around the Ox axis, and around the Oy axis. In this way, the lens barrel 100 can adjust the position of the lens frame 30B in the five-axis direction. Therefore, the optical properties of the lens barrel 100 can be easily adjusted to a desired state even in a case where an assembly error or the like has occurred in the lens frame 30A or the lens frame 30C. In other words, the manufacturing cost can be reduced because the dimensional accuracy and the assembly accuracy of the lens frame 30A or the lens frame 30C do not have to be strict.

In order to reduce the size of the lens barrel 100, it is necessary to reduce the number of lenses included therein. However, in order to reduce the number of lenses without deteriorating the image quality (resolution, chromatic aberration, and the like), it is necessary to increase the sensitivity of the entire lens barrel 100. The sensitivity refers to the amount of deviation of the condensing position of light with respect to the dimensional error and assembly error of the lens. The higher the sensitivity, the larger the deviation of the condensing position of light even with a slight dimensional error or assembly error. Therefore, the lens position is made to be adjustable in the five-axis direction as in the present embodiment, so that sufficient image quality can be realized even in a case where the sensitivity of the entire lens barrel 100 is increased, and as a result, it is possible to reduce the size of the lens barrel 100.

Further, with the lens barrel 100, since the protruding portion 31 is provided such that the reduced diameter portion of the cam follower 41 is located between the body portion 31a and the pin 31b, the adhesion area of the cam follower 41 and the protruding portion 31 can be enlarged. Therefore, it is possible to enhance the adhesive force between the protruding portion 31 and the cam follower 41 caused by the adhesive AD. Since the protruding portion 32 and the cam follower 42, the protruding portion 33 and the cam follower 43 have the same configuration as the protruding portion 31 and the cam follower 41, the adhesive force caused by the adhesive AD can also be enhanced.

Hereinafter, a preferred embodiment of the lens barrel 100 will be described.

### First Embodiment

It is preferable that the protruding portions 31, 32, and 33 and the cam followers 41, 42, and 43 are each made of a transparent material. The protruding portions 31, 32, and 33 and the cam followers 41, 42, and 43 are transparent in a case where a photocurable material such as an ultraviolet curable resin is used as the adhesive AD, so that it is easier to irradiate the entire adhesive AD with light, and it is possible to improve the sticking force and the sticking speed.

### Second Embodiment

As the adhesive AD, an adhesive AD that is cured by light having a specific wavelength range (for example, an ultraviolet range of a wavelength of 365 nm or more to a visible range) is preferably used for the sticking. With this configuration, the light can reach the inside of the adhesive AD, and the sticking force and the sticking speed can be improved.

### Third Embodiment

The adhesive AD is preferably an elastic adhesive. The elastic adhesive is, for example, a urethane resin or an adhesive containing a silicone resin as a main component. With this configuration, the impact resistance and vibration resistance of the lens barrel 100 can be enhanced even in a case where the cam follower and the lens frame are stuck to each other in a non-fastened state.

### Fourth Embodiment

The inner peripheral surfaces of the cam followers 41, 42, and 43 are preferably coated with an easily adhesive material. The easily adhesive material is a primer or the like. For example, Arrowbase (registered trademark) or Elitel (registered trademark) manufactured by Unitika LTD. may be used. With this configuration, the sticking force between the protruding portions 31, 32, and 33 and the cam followers 41, 42, and 43 can be enhanced. On the other hand, the cam followers 41, 42, and 43 are each made of a poor adhesive material such as fluororesin, so that the slidability with the cam barrel 5 can be secured.

### Fifth Embodiment

It is preferable that the inner peripheral surfaces of the cam followers 41, 42, and 43 are roughened by embossing processing, sand blasting, or the like. With this configuration, the sticking force between the protruding portions 31, 32, and 33 and the cam followers 41, 42, and 43 can be enhanced.

Hereinafter, a modification example of the lens barrel 100 will be described.

### First Modification Example

The protruding portions 31, 32, and 33 and the cam followers 41, 42, and 43 may be stuck to each other with soldering or welding, respectively, instead of the adhesive. According to this configuration, it is not necessary to consider contraction of the adhesive during curing, and sticking can be easily performed.

### Second Modification Example

The shapes of the cam follower and the protruding portion, which have been described above, are examples, and various configurations can be employed.

The body portions 31a, 32a, and 33a are not limited to a cylindrical shape, and may have, for example, a polygonal prismatic shape. The shape of the shaft portion 311 of the protruding portion 31 is not limited to a cylindrical shape, and may be, for example, a prismatic shape. The shape of the flat plate portion 310 of the protruding portion 31 is not limited to a circular plate shape, and may be, for example, a polygonal plate shape. Further, the protruding portions 31, 32, and 33 are not limited to a columnar shape, and may have another shape as long as the protruding portions 31, 32, and 33 and the interior walls of the cam followers 41, 42, and 43 have gaps by which the lens frame 30B can be moved to an optimal position therebetween and the protruding portions 31, 32, and 33 can be stuck to the cam followers 41, 42, and 43 inside the cam followers 41, 42, and 43, respectively. Further, the shapes of the openings of the reduced diameter portions 41a, 42a, and 43a of the cam followers 41, 42, and 43 are not limited to a circular shape, and may be, for example, a polygonal shape.

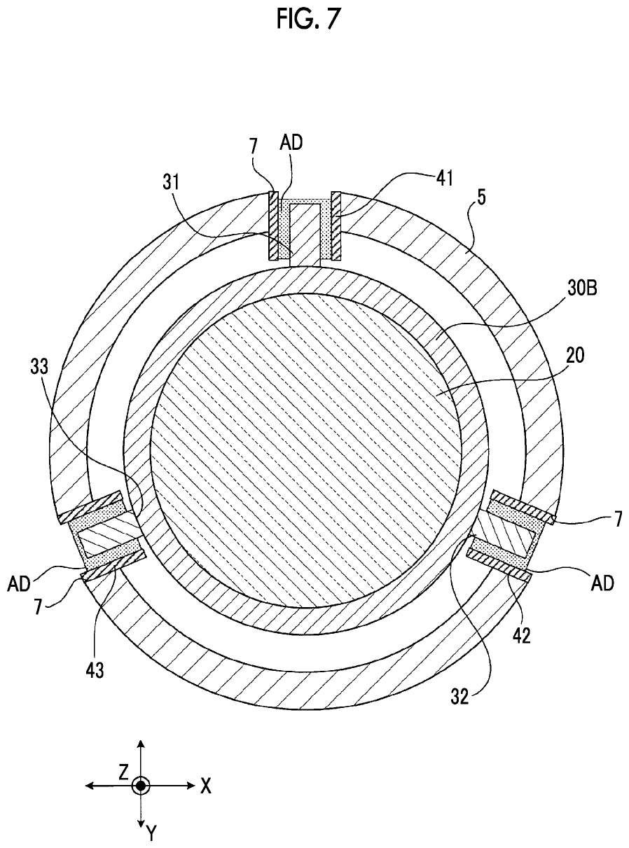

Further, as shown in FIG. 7, the protruding portions 31, 32, and 33 may each have a cylindrical or prismatic shape extending in the radial direction, and the cam followers 41, 42, and 43 may each have a cylindrical shape inside which the reduced diameter portion is not provided. With this configuration, the configurations of the cam follower and the protruding portion can be simplified, and the manufacturing cost can be reduced.

As described above, the following matters are disclosed in the present specification. Note that the constituents and the like corresponding to the above-described embodiments are shown in parentheses, but the present invention is not limited thereto.

(1)

A lens barrel comprising:

a tubular cam follower (cam follower 41);

a cam barrel (cam barrel 5) having a cam groove (cam groove 9) that is engaged with the cam follower; and

a lens support member (lens frame 30B) that supports a lens (lens group 20),

in which the lens support member has a protruding portion (protruding portion 31) that protrudes outward in a radial direction of the lens from an outer peripheral portion of the lens support member and that is inserted into the cam follower, and

the cam follower and the lens support member are stuck to each other in a non-fastened state (lens barrel 100).

(2)

The lens barrel according to (1),

in which the cam follower has one or zero contact surfaces that come into contact with the lens support member inside the cam follower and in an axial direction.

(3)

The lens barrel according to (1),

in which the cam follower has a plurality of contact surfaces that come into contact with the lens support member in an axial direction, and

the number of contact surfaces that overlap with the other contact surface as viewed in the axial direction, out of the plurality of contact surfaces, is zero.

(4)

The lens barrel according to (1),

in which three sets of the protruding portion and the cam follower are provided at an equal interval in a circumferential direction of the lens, and

in a first set (cam follower 41 and protruding portion 31) out of the three sets (cam follower 41 and protruding portion 31, cam follower 42 and protruding portion 32, and cam follower 43 and protruding portion 33), a gap is formed in a specific direction between the protruding portion and an interior wall of the cam follower, and a size of the gap is equal to or less than a size of a gap in the specific direction formed between the protruding portion and an interior wall of the cam follower in each of two second sets (cam follower 42 and protruding portion 32, and cam follower 43 and protruding portion 33) except the first set out of the three sets.

(5)

The lens barrel according to (4),

in which the specific direction is at least one of a movement direction (direction Z) of the lens, an axial direction (direction Y) of the cam follower, or a direction (direction X) orthogonal to the movement direction and the axial direction.

(6)

The lens barrel according to (1),

in which a gap in a specific direction is formed between the protruding portion and an interior wall of the cam follower, and

the specific direction is a movement direction (direction Z) of the lens, an axial direction (direction Y) of the cam follower, and a direction (direction X) orthogonal to the movement direction and the axial direction.

(7)

The lens barrel according to any one of (1) to (5),

in which an interior wall of the cam follower and the protruding portion are stuck to each other with a gap in an axial direction of the cam follower therebetween.

(8)

The lens barrel according to (1),

in which three sets of the protruding portion and the cam follower are provided at an equal interval in a circumferential direction of the lens.

(9)

The lens barrel according to (8),

in which in each of the three sets, the protruding portion and an interior wall of the cam follower are not in contact with each other.

(10)

The lens barrel according to any one of (1) to (9),

in which the protruding portion and the cam follower are stuck to each other with an adhesive (adhesive AD), solder, or welding.

(11)

The lens barrel according to any one of (1) to (10),

in which an inner peripheral surface of the cam follower is coated with an easily adhesive material.

(12)

The lens barrel according to any one of (1) to (11),

in which an inner peripheral surface of the cam follower is roughened.

(13)

The lens barrel according to any one of (1) to (12),

in which the protruding portion and the cam follower are each formed of a transparent material.

(14)

The lens barrel according to any one of (1) to (13),

in which the protruding portion and the cam follower are stuck to each other with an adhesive, and

the adhesive is cured by light having a specific wavelength range.

(15)

The lens barrel according to any one of (1) to (13),

in which the protruding portion and the cam follower are stuck to each other with an elastic adhesive.

(16)

The lens barrel according to any one of (1) to (15),

in which a length of the protruding portion in one direction out of two directions (direction X and direction Z) orthogonal to an axial direction of the cam follower and orthogonal to each other is shorter than a length of an interior of the cam follower in the one direction.

(17)

The lens barrel according to (16),

in which a length of the protruding portion in the other direction out of the two directions is shorter than a length of the interior of the cam follower in the other direction.

(18)

A lens device comprising the lens barrel according to any one of (1) to (17).

(19)

A manufacturing method of a lens barrel including a lens support member that supports a lens, a protruding portion that protrudes outward in a radial direction of the lens from an outer peripheral portion of the lens support member, a tubular cam follower into which the protruding portion is inserted and inside which the cam follower and the protruding portion are stuck to each other, and a cam barrel having a cam groove that is engaged with the cam follower, the manufacturing method comprising:

moving the protruding portion in a state in which the lens support member with the protruding portion inserted into the cam follower is disposed inside the cam barrel, determining a position of the protruding portion on the basis of an image obtained by imaging a test chart (resolution chart 104) via the lens in each movement position, and then sticking the protruding portion and the cam follower to each other at the position.

(20)

A lens barrel comprising:

a tubular cam follower (cam follower 41);

a cam barrel (cam barrel 5) having a cam groove (cam groove 9) that is engaged with the cam follower; and

a lens support member (lens frame 30B) that supports a lens (lens group 20),

in which the lens support member has a protruding portion (protruding portion 31) that protrudes outward in a radial direction of the lens from an outer peripheral portion of the lens support member and that is inserted into the cam follower,

three sets of the protruding portion and the cam follower are provided at an equal interval in a circumferential direction of the lens, and

in a first set out of the three sets, a gap is formed in a specific direction between the protruding portion and an interior wall of the cam follower, and a size of the gap is equal to or less than a size of a gap in the specific direction formed between the protruding portion and an interior wall of the cam follower in the specific direction in each of two second sets except the first set out of the three sets.

(21)

A lens barrel comprising:

a tubular cam follower (cam follower 41);

a cam barrel (cam barrel 5) having a cam groove (cam groove 9) that is engaged with the cam follower; and

a lens support member (lens frame 30B) that supports a lens (lens group 20),

in which the lens support member has a protruding portion (protruding portion 31) that protrudes outward in a radial direction of the lens from an outer peripheral portion of the lens support member and that is inserted into the cam follower,

the cam follower has one or zero contact surfaces that come into contact with the lens support member inside the cam follower and in an axial direction.

(22)

A lens barrel comprising:

a tubular cam follower (cam follower 41);

a cam barrel (cam barrel 5) having a cam groove (cam groove 9) that is engaged with the cam follower; and

a lens support member (lens frame 30B) that supports a lens (lens group 20),

in which the lens support member has a protruding portion (protruding portion 31) that protrudes outward in a radial direction of the lens from an outer peripheral portion of the lens support member and that is inserted into the cam follower,

the cam follower has a plurality of contact surfaces that come into contact with the lens support member in an axial direction, and

the number of contact surfaces that overlap with the other contact surface as viewed in the axial direction, out of the plurality of contact surfaces, is zero.

(23)

A lens barrel comprising:

a tubular cam follower (cam follower 41);

a cam barrel (cam barrel 5) having a cam groove (cam groove 9) that is engaged with the cam follower; and

a lens support member (lens frame 30B) that supports a lens (lens group 20),

in which the lens support member has a protruding portion (protruding portion 31) that protrudes outward in a radial direction of the lens from an outer peripheral portion of the lens support member and that is inserted into the cam follower,

a gap is formed in a specific direction between the protruding portion and an interior wall of the cam follower, and

the specific direction is a movement direction of the lens, an axial direction of the cam follower, and a direction orthogonal to the movement direction and the axial direction.

Although various embodiments have been described above with reference to the drawings, it goes without saying that the present invention is not limited to such examples. It is obvious that those skilled in the art can conceive various changes or modifications within the scope described in the claims, and naturally, such changes or modifications also belong to the technical scope of the present invention. In addition, any combination of constituents in the embodiment may be used without departing from a gist of the invention.

Note that the present application is based on a Japanese patent application filed on Sep. 30, 2019 (JP2019-180137), the contents of which are incorporated herein by reference.

### EXPLANATION OF REFERENCES

width: y1, x1, z1, L
2: mount ring
3: focus ring
4: focus lens barrel
5: cam barrel
6: fixed barrel
7, 8, 9: cam groove
11, 12, 41, 42, 43: cam follower
20: lens group
30A, 30B, 30C: lens frame
31a, 32a, 33a: body portion
31b, 32b, 33b: pin
31, 32, 33: protruding portion
41a, 42a, 43a: reduced diameter portion
41b: opening
100a, 100: lens barrel
101: imaging device
102: control device
103: industrial robot
104: resolution chart
200: manufacturing system
310: flat plate portion
311: shaft portion

What is claimed is:

1. A lens barrel comprising:
a tubular cam follower;
a cam barrel having a cam groove that is engaged with the cam follower; and
a lens support member that supports a lens,
wherein the lens support member has a protruding portion that protrudes outward in a radial direction of the lens from an outer peripheral portion of the lens support member and that is inserted into the cam follower, and
the cam follower and the lens support member are stuck to each other in a non-fastened state.

2. The lens barrel according to claim 1,
wherein the cam follower has one or zero contact surface that is to be in contact with the lens support member inside the cam follower and in an axial direction of the cam follower.

3. The lens barrel according to claim 1,
wherein the cam follower has a plurality of contact surfaces that are to be in contact with the lens support member in an axial direction of the cam follower, and
number of contact surfaces that overlap with other contact surface as viewed in the axial direction, among the plurality of contact surfaces, is zero.

4. The lens barrel according to claim 1,
wherein three sets of the protruding portion and the cam follower are provided at an equal interval in a circumferential direction of the lens, and
in a first set among the three sets, a gap is provided in a specific direction between the protruding portion and an interior wall of the cam follower, and a size of the gap is equal to or less than a size of a gap in the specific direction provided between the protruding portion and an interior wall of the cam follower in each of two second sets being other than the first set among the three sets.

5. The lens barrel according to claim 4,
wherein the specific direction is at least one of a movement direction of the lens, an axial direction of the cam follower, or a direction orthogonal to the movement direction and the axial direction.

6. The lens barrel according to claim 1,
wherein a gap in a specific direction is provided between the protruding portion and an interior wall of the cam follower, and
the specific direction is each of a movement direction of the lens, an axial direction of the cam follower, and a direction orthogonal to the movement direction and the axial direction.

7. The lens barrel according to claim 1,
wherein an interior wall of the cam follower and the protruding portion are stuck to each other with a gap in an axial direction of the cam follower therebetween.

8. The lens barrel according to claim 1,
wherein three sets of the protruding portion and the cam follower are provided at an equal interval in a circumferential direction of the lens.

9. The lens barrel according to claim 8,
wherein, in each of the three sets, the protruding portion and an interior wall of the cam follower are not in contact with each other.

10. The lens barrel according to claim 1,
wherein the protruding portion and the cam follower are stuck to each other with an adhesive, solder, or welding.

11. The lens barrel according to claim 1,
wherein an inner peripheral surface of the cam follower is coated with an easily adhesive material.

12. The lens barrel according to claim 1,
wherein an inner peripheral surface of the cam follower is roughened.

13. The lens barrel according to claim 1,
wherein the protruding portion and the cam follower are each formed of a transparent material.

14. The lens barrel according to claim 1,
wherein the protruding portion and the cam follower are stuck to each other with an adhesive, and
the adhesive is cured by light having a specific wavelength range.

15. The lens barrel according to claim 1,
wherein the protruding portion and the cam follower are stuck to each other with an elastic adhesive.

16. The lens barrel according to claim 1,
wherein a length of the protruding portion in one direction among two directions orthogonal to an axial direction of the cam follower and orthogonal to each other is shorter than a length of an interior of the cam follower in the one direction.

17. The lens barrel according to claim 16,
wherein a length of the protruding portion in other direction among the two directions is shorter than a length of the interior of the cam follower in the other direction.

18. A lens device comprising the lens barrel according to claim 1.

19. A manufacturing method of a lens barrel including a lens support member that supports a lens, a protruding portion that protrudes outward in a radial direction of the lens from an outer peripheral portion of the lens support member, a tubular cam follower into which the protruding portion is inserted and inside which the cam follower and the protruding portion are stuck to each other, and a cam barrel having a cam groove that is engaged with the cam follower, the manufacturing method comprising:
moving the protruding portion in a state in which the lens support member with the protruding portion inserted into the cam follower is disposed inside the cam barrel; determining a position of the protruding portion based on an image obtained by imaging a test chart via the lens in each of the moved positions; and sticking the protruding portion and the cam follower to each other at the determined position.

20. A lens barrel comprising:
a tubular cam follower;
a cam barrel having a cam groove that is engaged with the cam follower; and
a lens support member that supports a lens,
wherein the lens support member has a protruding portion that protrudes outward in a radial direction of the lens from an outer peripheral portion of the lens support member and that is inserted into the cam follower,
three sets of the protruding portion and the cam follower are provided at an equal interval in a circumferential direction of the lens, and
in a first set among the three sets, a gap is provided in a specific direction between the protruding portion and an interior wall of the cam follower, and a size of the gap is equal to or less than a size of a gap in the specific direction provided between the protruding portion and an interior wall of the cam follower in each of two second sets being other than the first set among the three sets.

21. A lens barrel comprising:
a tubular cam follower;
a cam barrel having a cam groove that is engaged with the cam follower; and
a lens support member that supports a lens,
wherein the lens support member has a protruding portion that protrudes outward in a radial direction of the lens from an outer peripheral portion of the lens support member and that is inserted into the cam follower, and
the cam follower has one or zero contact surface that is to be in contact with the lens support member inside the cam follower and in an axial direction of the cam follower.

22. A lens barrel comprising:
a tubular cam follower;
a cam barrel having a cam groove that is engaged with the cam follower; and
a lens support member that supports a lens,
wherein the lens support member has a protruding portion that protrudes outward in a radial direction of the lens from an outer peripheral portion of the lens support member and that is inserted into the cam follower,
the cam follower has a plurality of contact surfaces that are to be in contact with the lens support member in an axial direction of the cam follower, and
number of contact surfaces that overlap with other contact surface as viewed in the axial direction, among the plurality of contact surfaces, is zero.

23. A lens barrel comprising:
a tubular cam follower;
a cam barrel having a cam groove that is engaged with the cam follower; and
a lens support member that supports a lens,
wherein the lens support member has a protruding portion that protrudes outward in a radial direction of the lens from an outer peripheral portion of the lens support member and that is inserted into the cam follower,
a gap is provided in a specific direction between the protruding portion and an interior wall of the cam follower, and
the specific direction is each of a movement direction of the lens, an axial direction of the cam follower, and a direction orthogonal to the movement direction and the axial direction.
